(19) United States
(12) Patent Application Publication
(10) Pub. No.: US 2012/0114440 A1
(43) Pub. Date: May 10, 2012

(54) DRILL

(76) Inventor: Dieter Kress, Quebec (DE)

(21) Appl. No.: 13/384,523

(22) PCT Filed: Jul. 2, 2010
(86) PCT No.: PCT/EP2010/003993

§ 371 Date: Jan. 17, 2012

(30) Foreign Application Priority Data
Jul. 14, 2009 (DE) 10 2009 033 942.6

(51) Int. Cl. B23B 51/00

(52) U.S. Cl. 408/227

(57) ABSTRACT

A drill (1) for producing a drilled hole in workpieces comprising fibre-reinforced plastic is proposed, with at least one main cutting edge (3) on the end face, with at least one secondary cutting edge (11), provided in the region of a circumferential surface (9) of the drill (1), and with circularly ground lands (21), circumferentially adjoining the at least one secondary cutting edge (11, 11′). The drill is distinguished by the fact that the preferably continuous circularly ground lands (21) have, starting from a front region of the drill (1), a first longitudinal portion (22) with a first width (B1) and, adjoining thereto, a second longitudinal portion (24) with a second width (B2), wherein the width (B1) of the first longitudinal portion (22) is less, preferably less by a multiple, than the width (B2) of the second longitudinal portion (24).

The invention relates to a drill for producing boreholes in workpieces comprising fiber-reinforced plastics according to the preamble of claim 1.

In machining materials comprising glass-fiber-reinforced or carbon-fiber-reinforced plastic, for example, it is important, among other things, for the fibers to be cut cleanly at the cut edges and not to be ripped out of the workpiece composite. Unclean edges, i.e., frayed edges with protruding fibers require a great effort and thus a high cost for reworking or may even render the machined workpieces unusable. When such materials are drilled, frayed edges or so-called delamination may occur in particular at the outlet of the borehole, where the drill penetrates through the workpiece, but this is very problematical in rivet holes in structural parts in aircraft construction, for example.

DE 202 09 768 U1 describes a drill of the type described here. It has two main cutting edges on its end face, developing into secondary cutting edges provided in the peripheral area of the drill. The main cutting edges are formed by adjacent cutting faces and channels. The chips removed by the main cutting edge run down the cutting surfaces. A chisel edge is provided in the area of the central axis of the drill, the two main cutting edges on the end faces being adjacent thereto. Secondary cutting edges having a positive cutting angle are provided in the area of a peripheral face, such that each main cutting edge is allocated a secondary cutting edge. To prevent delamination, also in machining harder layers of the workpiece, the drill has a predrill section of a smaller diameter in the area of its tip and a precision machined section of a larger diameter which follows in the direction opposite the direction of feed of the drill. Secondary cutting edges provided on the precision machined section are connected at the periphery to circular grinding chamfers, which serve to provide centering support of the drill on the wall of the borehole during the drilling operation. The width of the circular grinding chamfers increases linearly with an increase in the distance from the main cutting edges. The disadvantage is that the drilling result does not meet the requirements with regard to the surface quality of the wall of the borehole and the dimensional precision of the borehole in all cases and therefore needs improvement. Furthermore, the effort and thus the production cost of the drill are relatively high.

The object of the invention is therefore to create a drill of the type defined in the introduction, which does not cause any delamination, i.e., no separation of fibers, in particular also at the outlet of the borehole, and to create a drill by means of which accurate boreholes and good surface qualities of the wall of the borehole can be produced nevertheless.

To achieve this object, a drill having the features specified in claim 1 is proposed. This drill comprises at least one main cutting edge on the end face, connected to a secondary cutting edge in the area of the peripheral face of the drill. On the periphery, there is a circular grinding chamfer whose width increases with an increase in the distance from the main cutting edges over a defined length. The drill is characterized in that the circular grinding chamfer has a first longitudinal section with a first width, starting from the forward area of the drill, and connected thereto a second longitudinal section with a second width, such that the width of the first longitudinal section is smaller, preferably many times smaller, than the width of the second longitudinal section. The circular grinding chamfer is preferably designed to be continuous, i.e., it extends from the edge that is present at the tip of the drill, where the main cutting edge develops into the secondary cutting edge and/or is adjacent thereto, in the direction of a fastening section, for example, a shaft of the drill along the secondary cutting edge preferably over its entire length, in particular, however, at least over a length of the drill, which is the same as the defined working depth of the drill.

The circular grinding chamfer is thus extremely narrow in the forward area of the drill, i.e., in the area of its first longitudinal section, and preferably has a constant or essentially constant width. The effect of this geometry is more or less as if the secondary cutting edge did not have a circular grinding chamfer but instead has a clearance angle. Wear on the drill is only minor, based on the small contact area between the circular grinding chamfer in the area of its first longitudinal section and the wall of the borehole, so that longer service lifetimes of the drill can be achieved easily. Nevertheless, these very narrow circular grinding chamfers produce adequate support and guidance and thus stabilize the cutting edges of the drill, so that accurate boreholes having a high surface quality can be produced. Furthermore, the drill cuts off the fibers in fiber-reinforced plastics very reliably because of the very narrow circular grinding chamfers in the area of their first longitudinal section, so that delamination of the layers or fraying of the edges of such a plastic material comprising such fibers can be prevented in particular even in the outlet area of the drill in the workpiece.

The circular grinding chamfer preferably also has a constant or essentially constant width in the direction of a fastening shaft and/or fastening section or the like of the drill on the second longitudinal section, which follows the first longitudinal section, this width being significantly greater than the width of the circular grinding chamfers on their first longitudinal section to optimally support the drill in the borehole.

In contrast with the known drill, which has a predrill section of a smaller diameter and a precision machined section having the finished diameter, the inventive drill preferably has only a single uniform machining diameter, which permits inexpensive production of the drill.

The first longitudinal section of the circular grinding chamfers having a reduced width is also referred to below simply as the “visible chamfer” and the second longitudinal section, which follows the visible chamfer and has a greater width, is also referred to briefly as merely a “circular grinding chamfer.”

A particularly preferred exemplary embodiment of the drill is characterized in that the width of the first longitudinal section of the circular grinding chamfers, i.e., the visible chamfer is in a range from 0.01 mm to 0.1 mm. It has been found that in the case of visible chamfers with a width of 0.05 mm, an especially good working result can be achieved with the drill.

An exemplary embodiment of the drill in which the length of the visible chamfers is in the range of 1 mm to 3 mm is especially preferred. Thus, the visible chamfers are extremely short in comparison with the total axial extent of the circular grinding chamfers.

According to one refinement, the drill is provided with a hard coating at least in the area of its visible chamfers, and the width of the visible chamfers, which serve essentially only to define the diameter of the drill, is minimal and preferably amounts to a technologically producible minimum. It has been found that the narrower the visible chamfers are, the more reliable the cut of the fibers present in the area of the borehole. The coating may be a diamond coating, for example, which adequately protects the cutting edges against wear/abrasion and breakage, even in the sharp-ground state.

A preferred exemplary embodiment of the drill is characterized in that the width of the second longitudinal section of the circular grinding chamfers is in the range of 0.3 mm to 0.8 mm. It has been found that a width of 0.4 mm to 0.7 mm is especially recommended. The longitudinal section of the circular grinding chamfer following the visible chamfer thus has a much greater width than the width of the visible chamfer.

In another preferred exemplary embodiment of the drill, the transition between the first and second longitudinal sections of the circular grinding chamfers is designed as a step. This step may be designed, so that the transition from the visible chamfer to the second longitudinal section, which follows axially in the direction of the shaft of the drill occurs at a defined axial position of the drill, so that an essentially Z-shaped edge contour of the circular grinding chamfers is obtained. In another exemplary embodiment, the step forming the transition is designed in the form of a bow. The step, which has a bow-shaped course in a top view of the circular grinding chamfers, may be formed by a preferably bevel-ground channel.

In another preferred exemplary embodiment of the drill, the secondary cutting edges are each provided with at least one open recess. Fibers present in the workpiece may be more or less captured in this recess and subsequently cut off securely by the secondary cutting edge. The recesses may be embodied as notches, for example, which are preferably ground, laser cut or eroded in the secondary cutting edges.

According to one refinement, the secondary cutting edges are each provided with multiple open recesses arranged at a distance from one another. This ensures that when fibers present in the workpiece are not captured in the first recesses as seen in the direction of advance of the drill and are cut off in the secondary cutting edge sections present between recesses arranged next to one another, then are captured and next cut off by the next recess or the next-but-one recess. The working result of the drill can therefore be further optimized.

In a preferred exemplary embodiment of the drill, the longitudinal extent of the recesses is smaller than the width of the circular grinding chamfers in the area of the recesses. This reliably prevents fibers from being drawn in between the drill and the wall of the borehole, which might result in breaking of the fibers.

In a preferred embodiment, the at least one recess on the secondary cutting edges is arranged in the area of the second longitudinal section of the circular grinding chamfers, i.e., not in the area of the very narrow visible chamfer.

In addition, an exemplary embodiment of the drill, which is characterized by a point angle at the chisel edge and/or between the main cutting edges of less than 90°, is preferred. This embodiment of the end of the drill makes it possible to prevent delamination, which usually occurs at the tip of the drill.

The drill may be designed as a spiral drill, for example, or as a drill having secondary cutting edges running parallel to the longitudinal central axis and as straight grooved chucking grooves.

The drill preferably has two main cutting edges, two respective secondary cutting edges optionally running in the form of a spiral, each having a circular grinding chamfer as described above. However, it is also conceivable—as explained above—for the drill to have only one main cutting edge and only one secondary cutting edge allocated to it, having a connected circular grinding chamfer as described above. However, more than two, for example, three or four main cutting edges may of course also be provided, each having a respective secondary cutting edge with a circular grinding chamfer connected thereto.

Additional advantageous embodiments of the drill are derived from the subclaims.

The invention is explained in greater detail below on the basis of the drawings, in which:

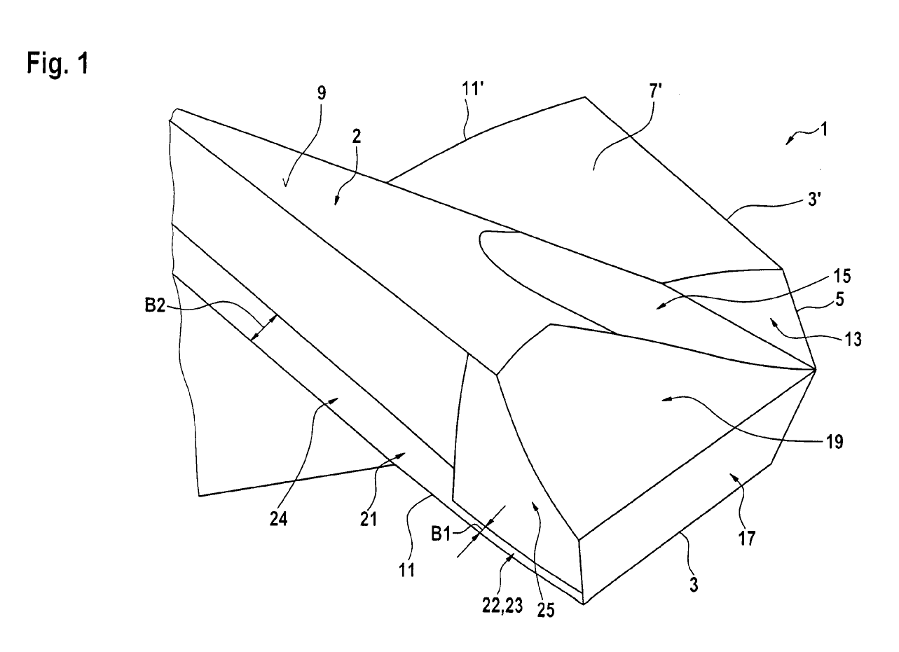

FIG. 1 shows in a perspective diagram a portion of a first exemplary embodiment of a drill from the front obliquely to its tip;

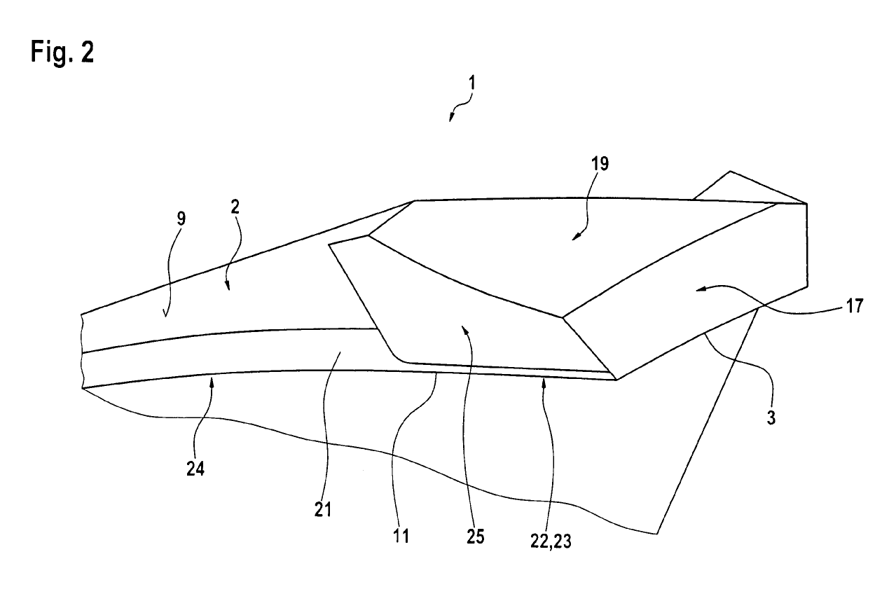

FIG. 2 shows another perspective diagram of the drill according to FIG. 1 with a view of a secondary cutting edge from above;

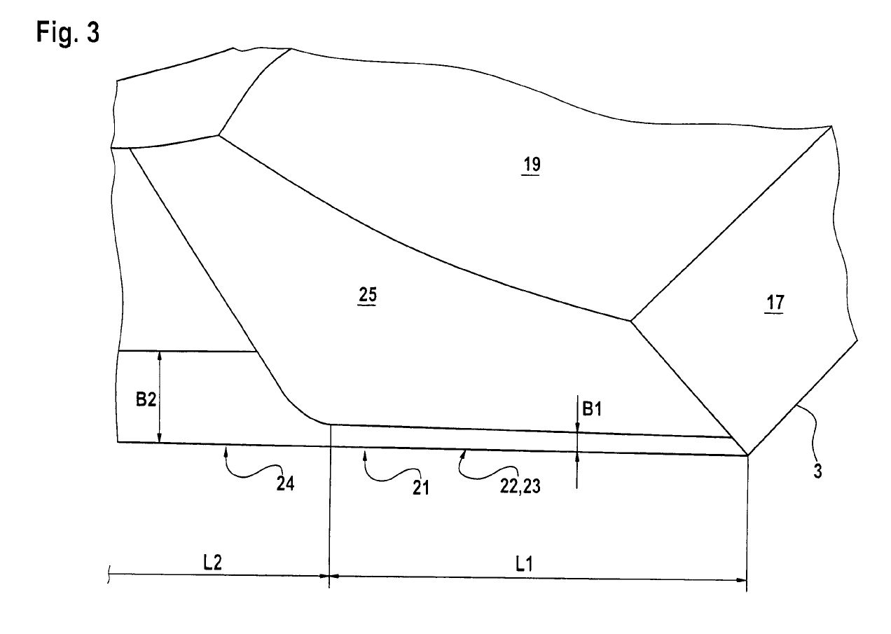

FIG. 3 shows a perspective diagram of an enlarged detail of the drill according to FIGS. 1 and 2 in the area of its tip with the view in the direction of the secondary cutting edge, and

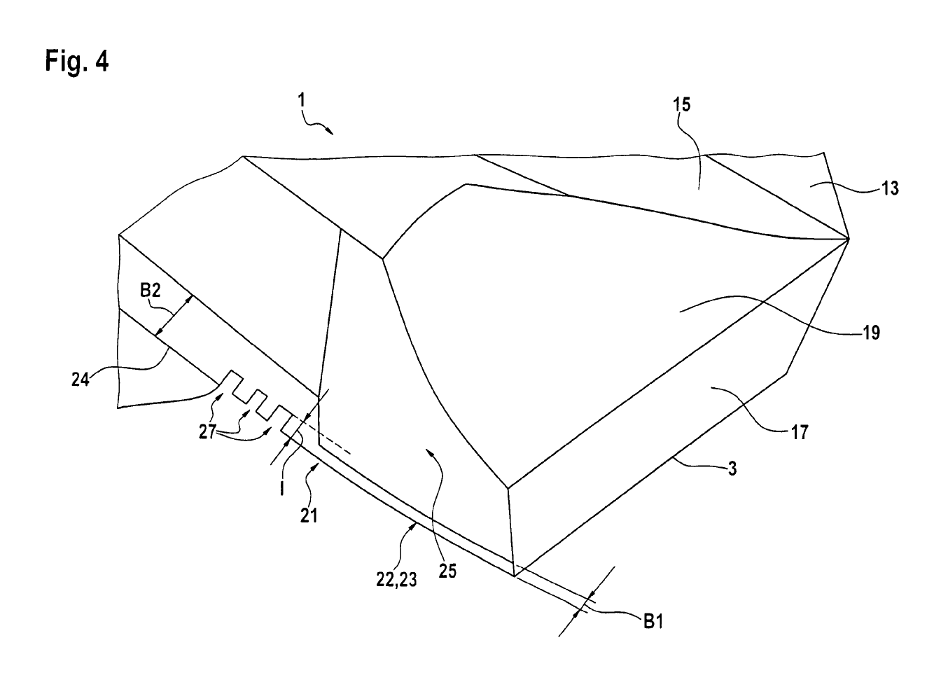

FIG. 4 shows a perspective diagram of a part of a second exemplary embodiment of a drill from the front obliquely to its tip.

FIG. 1 shows a perspective diagram of a detail of a first exemplary embodiment of a drill 1. The direction of view is from the upper front obliquely to the tip of the drill 1.

In the exemplary embodiment shown here, the drill 1 is designed as a spiral drill and has a base body 2 on which a first main cutting edge 3 and a second main cutting edge 3′ arranged with point symmetry with the central axis of the drill 1 are provided. The two main cutting edges 3, 3′ in this exemplary embodiment are preferably joined to one another by a chisel edge 5 running through the central axis. The two main cutting edges 3, 3′ are preferably arranged parallel to a diametric line running through the central axis—as seen from above onto an end face of the drill 1. The main cutting edges form an angle to one another, which is generally referred to as the point angle, of less than 90°. The end of the drill having the main cutting edges is therefore relatively pointed.

A cutting face is allocated to each main cutting edge 3, 3′; the diagram in FIG. 1 shows only the cutting face 7′ allocated to the second main cutting edge 3′. The cutting faces have a positive cutting angle, i.e., they fall back in the direction of rotation of the drill, which results in an oblique shearing cut. In rotation of the drill 1, which is counterclockwise, as seen in a view of its end face from above, the main cutting edge 3′ moves out of the plane of FIG. 1, while the other main cutting edge 3 is shifted into the plane of the figure.

The main cutting edges 3, 3′ develop into secondary cutting edges 11 and 11′ arranged in the area of the peripheral face 9 of the drill 1. The secondary cutting edges 11 and 11′ are aligned essentially parallel to the central axis of the drill in the case of straight grooves but they run along an imaginary helical line in the exemplary embodiment shown here.

In the area of chisel edge 5, the cutting properties of the drill 1 are poor, so these should be as short as possible.

This is achieved by a point 13, which is preferably produced by a special grinding technique. Because of the chisel edge, which is thereby reduced/shortened, the feed force and thus the drill torque are reduced.

In the area of the end of the drill, additional channels 15, 17 and 19 are provided, although they are not described further here.

A circular grinding chamfer follows the secondary cutting edges 11 and 11′ on the periphery. In the diagram according to FIG. 1, only the circular grinding chamfer 21 allocated to the secondary cutting edge 11 can be discerned. The circular grinding chamfers of the secondary cutting edges 11 and 11′ are designed to be identical, so that only the circular grinding chamfer 21 is explained in greater detail below.

In this exemplary embodiment, the circular grinding chamfer 21 is designed to be continuous and extends from the forward end of the secondary cutting edge 11 in the direction of a shaft of the drill 1 (not shown). The circular grinding chamfer 21 has a first longitudinal section 22 with a first width B1, starting from the forward area of the drill, and has a second longitudinal section 24 connected thereto with a second width B2. It is readily apparent that the width B1 of the first longitudinal section 22 is significantly smaller, namely several times smaller than the width B2 of the second longitudinal section 24 of the circular grinding chamfer 21.

The first longitudinal section 22 of the circular grinding chamfer 21 with the width B1 is also referred to below as a reduced circular grinding chamfer or also as a visible chamfer 23 because of its very small width. The visible chamfer 23 has a radius corresponding to the radius of the borehole to be created, i.e., the machining diameter of the drill 1. The different width of the circular grinding chamfer 21 in its longitudinal sections described above is formed in the exemplary embodiment shown in the figures by a channel 25 produced by bevel grinding in the area of the first longitudinal section 22. The channel 25 extends to the peripheral face 9 of the drill 1, where it is adjacent to the channels 17 and 19. The course of the channel 25 is selected, so that it does not touch the wall of the borehole during a drilling operation.

As shown in FIG. 2, which illustrates another perspective diagram of an end area of the drill 1 according to FIG. 1, the transition between the visible chamfer 23 and the second longitudinal section 24 of the circular grinding chamfer 21 is designed in steps, such that the visible chamfer 23 develops into the second longitudinal section 24 in a bow-shaped course. The transition is especially gentle here and without any breaks. This form of the transition is readily obtained by grinding the channel 25 on the basis of the grinding in conjunction with the size, contour and geometry of the drill 1.

On the basis of FIG. 3, which shows a detail of the drill according to FIGS. 1 and 2 on an enlarged scale, the dimensions of the circular grinding chamfer 21 are explained in greater detail below.

The width B1 of the first longitudinal section 22 is preferably in the range of 0.01 mm to 0.1 mm and is in particular approx. 0.05 mm. The length L1 of the first longitudinal section 22 of the circular grinding chamfers 21 is extremely short and is preferably in the range of 1 mm to 3 mm. On the other hand, the second longitudinal section 24 has a greatly enlarged width B2, which is in the range of 0.3 mm to 0.8 mm. The second longitudinal section 24 preferably extends over the remaining area of the secondary cutting edge connected to the visible chamfer 23.

FIG. 4 shows another exemplary embodiment of a drill 1 in a perspective diagram. This view corresponds essentially to the perspective diagram according to FIG. 1. The same parts and parts having the same function are provided with the same reference numerals so that reference is made to the description of the preceding FIGS. 1 to 3.

In the particularly preferred exemplary embodiment of the drill 1 shown in FIG. 4, the secondary cutting edges 11 and 11′ are each provided with at least one open recess 27. In the exemplary embodiment according to FIG. 4, the secondary cutting edges 11 and 11′ each have multiple open recesses 27, namely a total of three recesses here, arranged a distance apart from one another.

The recesses 27 are designed as notches, which in this exemplary embodiment have a rectangular contour merely as an example. They are produced by grinding, laser cutting and/or eroding. It is readily possible to provide some other contour for the recesses 27. For example, they may also be designed to be V-shaped or in other shapes. It is important that the longitudinal extent I of the recesses 27 is smaller than the width of the circular grinding chamfer 21; The recesses 27 thus do not extend over the total width B2 of the [circular grinding chamfer] 21. In the exemplary embodiment of the drill 1 shown here, the recesses 27 are arranged in the area of the second longitudinal section 24 of the circular grinding chamfer 21. In other words, the longitudinal extent of the recesses 27 is smaller than 0.3 mm, amounting to approx. 0.15 mm here. The recesses 27 must ultimately be at least long enough so that the fibers of a machined workpiece protruding away from the workpiece are held in the recesses 27 and are subsequently cut off by the partial area of the secondary cutting edge 21, this partial area following a recess 27 in the axial direction and optionally present between two recesses.

In summary, it remains to be pointed out that in drilling workpieces comprising fiber-reinforced plastic but also workpieces made of a composite material and workpieces consisting entirely of fiber-reinforced plastic, comprising at least one layer of fiber-reinforced plastic and one metal layer, for example, of aluminum, delamination and frayed machining edges in particular at the point of breakthrough of the drill can be prevented by means of the drill described on the basis of the figures. Thus, if composite materials of fiber-reinforced plastic and metal, i.e., workpieces having a sandwich design, are machined, the advantages described here are obtained in particular when fiber-reinforced plastic is present on the outlet side of the borehole in such a workpiece. It is also advantageous that very precise boreholes with good surfaces can be produced. This is achieved in particular by the very narrow visible chamfer 23 extending over only a very small axial length of preferably approx. 1.0 mm to 3.0 mm. Due to the fact that visible chamfer is designed to be very narrow, the drill cuts off the fibers very reliably in fiber-reinforced plastics, so that the visible chamfer, which slides along the wall of the borehole and thereby stabilizes the cutting edges of the drill, is subject to only minor wear. Especially good results have been obtained when the drill has a point angle of less than 90°, in addition to the special design of the circular grinding chamfers. Due to this small point angle between the main cutting edges, this ensures that the resulting force components acting on the drill in the axial direction will be as small as possible.

1. (canceled)

2. The drill of claim 21 comprising at least two main cutting edges and at least two secondary cutting edges, a secondary cutting edge being allocated to each main cutting edge.

3. (canceled)

4. The drill of claim 21, wherein the width of the first longitudinal section of the circular grinding chamfers is in range from 0.01 mm to 0.1 mm.

5. The drill of claim 21 wherein the drill further comprises a hard coating at least in the area of the first longitudinal section of the circular grinding chamfers.

6. The drill of claim 21 wherein the width of the second longitudinal section of the circular grinding chamfers is between about 0.3 mm to about 0.8 mm.

7. The drill of claim 21 wherein of the first longitudinal section of the circular grinding chamfers has a length of between about 1 mm to about 3 mm.

8. The drill of claim 7 wherein the width of the first longitudinal section of the circular grinding chamfers is substantially constant over its length.

9. The drill of claim 21 wherein a transition between the first and second longitudinal sections of the circular grinding chamfers is a step.

10. The drill of claim 21 wherein the secondary cutting edges comprises at least one open recess.

11. The drill of claim 8 wherein the secondary cutting edges are each provided with multiple recesses that are open at the edges and are arranged at a distance from one another.

12. The drill of claim 11 a longitudinal extent of the recesses is smaller than the width of the circular grinding chamfers in the area of the recesses.

13. The drill of claim 10 wherein the at least one recess is arranged on the secondary cutting edges in the area of the second longitudinal section of the circular grinding chamfers.

14. The drill of claim 21 further comprising a point angle on a chisel edge which is less than 90°.

15. The drill of claim 6, wherein the width of the second longitudinal section of the circular grinding chamfers is between about 0.4 mm to about 0.7 mm.

16. The drill of claim 7, wherein the width of the second longitudinal section of the circular grinding chamfers is substantially constant over its length.

17. The drill of claim 21, wherein the circular grinding chamfers are continuous.

18. The drill of claim 5 wherein the hard coating is a diamond coating.

19. The drill of claim 4, wherein the width of the first longitudinal section of the circular grinding chamfers is about 0.05 mm.

20. The drill of claim 10, wherein the at least one open recess is a notch.

21. A drill for producing a borehole in workpieces comprising fiber-reinforced plastic, the drill comprising:
(a) at least one main cutting edge on an end,
(b) at least one secondary cutting edge provided in the area of a peripheral face of the drill, and
(c) circular grinding chamfers following the at least one secondary cutting edge on a periphery, the circular grinding chamfers comprising, starting from a forward area of the drill:
(i) a first longitudinal section having a width and
(ii) a secondary longitudinal section having a width and connected to the first longitudinal section, such that the width of the first longitudinal section is smaller than the width of the second longitudinal section.
